(19) United States
(12) Patent Application Publication
(10) Pub. No.: US 2015/0192425 A1
(43) Pub. Date: Jul. 9, 2015

(54) FACILITY SEARCH APPARATUS AND FACILITY SEARCH METHOD

(71) Applicants: Alpine Electronics, Inc., Tokyo (JP); Honda Motor Co., Ltd., Tokyo (JP)

(72) Inventors: Junya Mizuno, Iwaki (JP); Keisuke Kondo, Wako (JP)

(21) Appl. No.: 14/590,534

(22) Filed: Jan. 6, 2015

(30) Foreign Application Priority Data
Jan. 7, 2014 (JP) 2014/001087

(51) Int. Cl. G01C 21/36; G10L 15/08

(52) U.S. Cl. CPC G01C 21/3608; G10L 15/08

(57) ABSTRACT

An on-vehicle apparatus includes a microphone which inputs voice produced by a user, a speech example provision unit which provides a speech example for the user before the voice input is performed using the microphone, a hard disk device which stores registration information which is registered and updated in response to operations performed by the user and which includes an address itself or unique information used to specify the address, and a speech example setting unit which reads the registration information stored in the hard disk apparatus and set the address corresponding to the registration information as the speech example.

### RELATED APPLICATION

The present application claims priority to Japanese Application Number 2014-001087, filed Jan. 7, 2014, the entirety of which is hereby incorporated by reference.

### BACKGROUND

1. Field

The present disclosure relates to a facility search apparatus which inputs an address of a facility to be searched for by voice and a facility search method.

2. Description of the Related Art

A navigation system which prompts a user to perform voice input by outputting voice of a speech example such as a speech “input “Showa-cho, Kariya-shi, Aichi-ken”, for example” when an address is to be input by voice has been generally used (refer to Japanese Unexamined Patent Application Publication No. 11-38995, for example). Furthermore, an information processing apparatus which displays or outputs by voice a speech example for prompting input of data in a designated entry field when data is input to the predetermined data input field by voice has been generally used (refer to Japanese Unexamined Patent Application Publication No. 2004-21920, for example).

In the navigation system disclosed in Japanese Unexamined Patent Application Publication No. 11-38995 and the information processing apparatus disclosed in Japanese Unexamined Patent Application Publication No. 2004-21920, a speech example is displayed when voice input is to be performed, and the user may easily perform the voice input in accordance with a prescribed input format with reference to content of the display of the speech example. However, such a speech example is a fixed speech prepared in advance in the navigation system and the information processing apparatus, and it is possible that an address which is not familiar for the user is displayed as the speech example in response to an input of an address of a facility to be searched for, such that there arises a problem in that the example is far from an easily-understandable example.

### SUMMARY

The present disclosure is made in view of the problem described above. An object of the present disclosure is to provide a facility search apparatus capable of displaying a speech example which is familiar for a user when an address is to be input by voice and a facility search method.

To address the problem described above, a facility search apparatus according to the present disclosure provides voice collection means for inputting voice produced by a user, speech example provision means for providing a speech example for the user before the voice input is performed using the voice collection means, registration information storage means for storing registration information which is registered and updated in response to operations performed by the user and which includes an address itself or unique information used to specify the address, and speech example setting means for reading the registration information stored in the registration information storage means and setting the address corresponding to the registration information as the speech example.

Furthermore, a facility search method according to the present disclosure provides collecting voice produced by a user using voice collection means, providing a speech example for the user using speech example provision means before the voice input is performed using the voice collection means, and reading registration information stored in registration information storage means and setting an address corresponding to the registration information as the speech example using speech example setting means when the registration information which is registered and updated in response to operations performed by the user and which includes an address itself or unique information used to specify the address is stored in the registration information storage means.

Since an address is extracted in accordance with information registered in response to a user's operation and is used as a speech example, a speech example which is familiar for the user may be displayed when an address is input by voice.

Furthermore, the speech example provision means described above preferably displays a character string representing content of the address serving as the speech example. By this, since an address is displayed in a form of a character string, the address may be displayed as a speech example which is familiar for the user.

In addition, voice recognition means for performing a voice recognition process on input voice collected by the voice collection means and facility search means for searching for a facility corresponding to an address represented by a character string obtained by the voice recognition process performed by the voice recognition means are preferably further provided. By this, the user may search for a desired facility only by inputting an address by voice with reference to a familiar speech example.

Furthermore, route search means for calculating a moving path to a destination by a route search process and destination setting means for setting the destination in response to a user's operation are preferably further provided. The registration information storage means preferably stores destinations set in the past by the destination setting means as the registration information. The destination of route search corresponds to a location where the user actually visited or a location where the user plans to visit. Since an address of the location is used as a speech example, the speech example which is familiar for the user may be reliably displayed.

Moreover, facility/address specifying means for specifying a facility or an address desired to be registered by the user in response to a user's operation is preferably further provided. The registration information storage means preferably stores facilities or addresses specified in the past by the facility/address specifying means as the registration information. Since a facility or an address in which the user desires to register is used as a speech example, a speech example which is familiar for the user may be reliably displayed.

Address specifying means for specifying an address corresponding to a person's name or a facility name as address information in response to a user's operation is preferably further provided. The registration information storage means preferably stores address information specified in the past by the address specifying means as the registration information. Since an address as address information specified by the user is used as a speech example, a speech example which is reliably familiar for the user may be displayed.

Furthermore, the speech example setting means preferably reads certain registration information which is most recently stored from among a plurality of registration information stored in the registration information storage means and sets an address corresponding to the read registration information as the speech example. Since the address of registration information which most recently relates to the user is used as a speech example, a speech example which is familiar for the user may be reliably displayed.

The speech example setting means preferably reads certain registration information randomly selected from among a plurality of registration information stored in the registration information storage means and sets an address corresponding to the read registration information as the speech example. By this, various addresses which are familiar for the user may be extracted every time a speech example is displayed, and a speech example which is not bored by the user may be displayed.

### BRIEF DESCRIPTION OF THE DRAWINGS

FIG. 1 is a diagram illustrating a configuration of an on-vehicle apparatus according to an embodiment;

FIG. 2 is a diagram illustrating content of destination history data;

FIG. 3 is a diagram illustrating content of point registration data;

FIG. 4 is a diagram illustrating content of address book data;

FIG. 5 is a flowchart illustrating a procedure of an operation of inputting an address of a facility to be searched for by voice; and,

FIG. 6 is a diagram illustrating a display screen displaying a speech example.

### DESCRIPTION OF THE PREFERRED EMBODIMENTS

Hereinafter, an embodiment of an on-vehicle apparatus to which a facility search apparatus of the present disclosure is applied will be described with reference to the accompanying drawings.

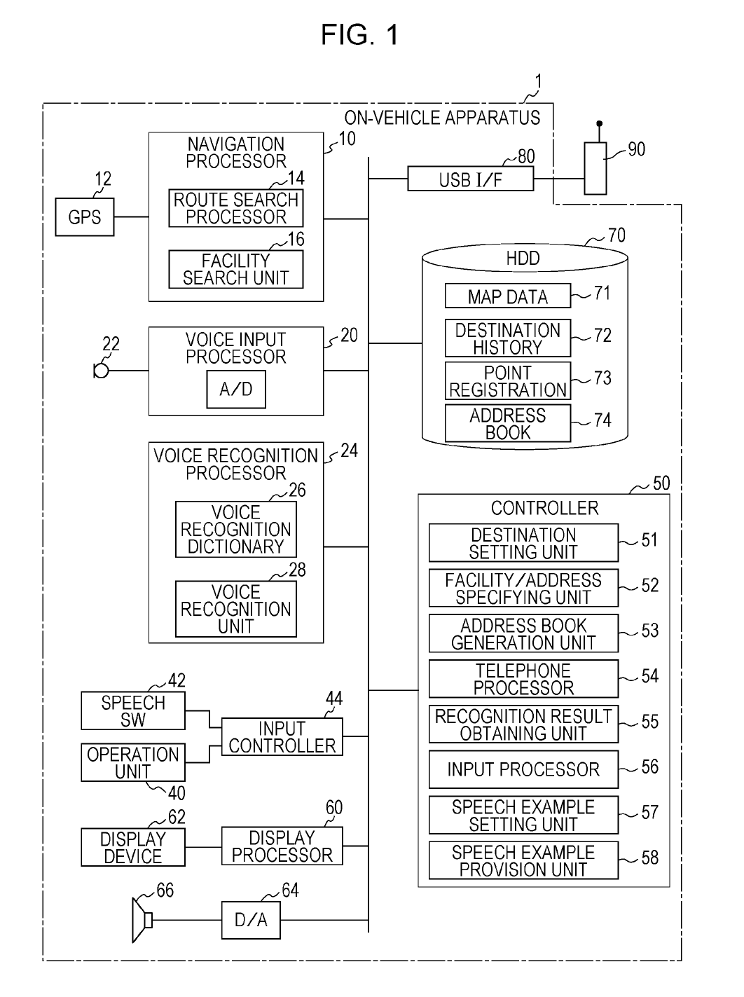

FIG. 1 is a diagram illustrating a configuration of an on-vehicle apparatus 1 according to an embodiment. As illustrated in FIG. 1, the on-vehicle apparatus 1 includes a navigation processor 10, a voice input processor 20, a voice recognition processor 24, an operation unit 40, a speech switch (SW) 42, an input controller 44, a controller 50, a display processor 60, a display device 62, a digital-analog converter (D/A) 64, a speaker 66, a hard disk device 70, and a USB (Universal Serial Bus) interface unit (USB I/F) 80.

The navigation processor 10 performs a navigation operation of guiding traveling of a vehicle including the on-vehicle apparatus 1 installed therein using map data 71 stored in the hard disk device 70. The navigation processor 10 is used together with a GPS device 12 which detects a user's vehicle position. The navigation operation which guides traveling of a vehicle includes, in addition to map display, a route search process performed by a route search processor 14 and a surrounding facility search process performed by a facility search unit 16. The detection of a user's vehicle position may be performed by combining the GPS device 12 with an autonomous navigation sensor, such as a gyro sensor or a vehicle velocity sensor.

The voice input processor 20 performs a process of inputting voice of a user (speaker) collected by a microphone 22. The voice input processor 20 includes an analog-digital converter (A/D), for example, which converts a signal output from the microphone 22 into digital voice data.

The voice recognition processor 24 including a voice recognition dictionary 26 and a voice recognition unit 28 performs a voice recognition process on voice collected by the microphone 22. The voice recognition dictionary 26 is used for the voice recognition process performed on at least an address pronounced by the user. In addition, operation commands for issuing operation instructions to the on-vehicle apparatus 1 may be included in targets of the voice recognition. The voice recognition unit 28 performs the voice recognition process on voice of the user collected by the microphone 22 using the voice recognition dictionary 26 so as to identify content (a character string) of an address pronounced by the user.

The operation unit 40 including various operation keys, various operation switches, and various operation levers is used to accept manual operations performed on the on-vehicle apparatus 1 by the user. Furthermore, when various operation screens and various input screens are displayed in the display device 62, one of items displayed in the operation screens and the input screens may be selected by directly pointing to a portion of the operation screens and the input screens by a user's finger or the like. A touch panel which detects a position of a finger which points to a screen is provided as a portion of the operation unit 40 so as to enable such operations using the operation screens and the input screens. Instead of the touch panel, a remote control unit and the like may be used to select a portion of the operation screens and the input screens in response to a user's instruction. The speech switch 42 is operated by the user when the user directs speech to the microphone 22 so as to instruct a speech timing. The input controller 44 monitors the operation unit 40 and the speech switch 42 and determines content of operations on the operation unit 40 and the speech switch 42.

The controller 50 controls the entire on-vehicle apparatus 1, and in addition, operates as a handsfree telephone system. The controller 50 is realized when a CPU executes an operation program stored in a ROM or a RAM. Although the navigation processor 10 and the voice recognition processor 24 are provided separately from the controller 50, some of functions of the navigation processor 10 and the voice recognition processor 24 may be realized by the controller 50. The controller 50 will be described in detail hereinafter.

The display processor 60 outputs video signals used to display the various operation screens, the various input screens, a screen including a map image generated by the navigation processor 10, and the like and causes the display device 62 to display the various screens. The digital-analog converter 64 converts voice data obtained when the on-vehicle apparatus 1 is operated as the handsfree telephone system and audio data representing a notification of an intersection generated by the navigation processor 10 into analog voice signals to be output from the speaker 66. Although an amplifier which amplifies signals is connected between the digital-analog converter 64 and the speaker 66 in practice, the amplifier is omitted in FIG. 1. Furthermore, although a number of combinations of the digital-analog converter 64 and the speaker 66 are provided for a number of reproduction channels, only one combination is illustrated in FIG. 1.

The hard disk device 70 stores, in addition to the map data 71, destination history data 72, point registration data 73, and address book data 74. The map data 71 is used for the navigation operation performed by the navigation processor 10 and includes, in addition to rendering data required for the map display, data required for route search, facility data (a name, an address, a telephone number, and the like of a facility) required for the facility search, and intersection notification data required for path guidance. The destination history data 72, the point registration data 73, and the address book data 74 will be described hereinafter.

The USB interface unit 80 is used to perform input of signals from and output of signals to a cellular phone 90 through a USB cable. The USB interface unit 80 includes a USB port and a USB host controller.

Next, the controller 50 will be described in detail. As illustrated in FIG. 1, the controller 50 includes a destination setting unit 51, a facility/address specifying unit 52, an address book generation unit 53, a telephone processor 54, a recognition result obtaining unit 55, an input processor 56, a speech example setting unit 57, and a speech example provision unit 58.

The destination setting unit 51 sets a destination to be used by the route search processor 14. For example, the destination setting unit 51 is used in a case where a facility which satisfies a specific search condition is searched for and is set as a destination or in a case where, in a state in which a map image is displayed in a screen of the display device 62, when the user specifies a portion of the map image using the operation unit 40, the specified position is set as a destination. The destination set by the destination setting unit 51 is used as a destination of the route search processor 14 and stored in the hard disk device 70 as the destination history data 72.

The destination history data 72 represents destinations set by the destination setting unit 51 and used in the past by the route search process performed by the route search processor 14. The destination history data 72 includes, for example, data specifying a predetermined number of destinations (10 from the latest setting date and time, for example).

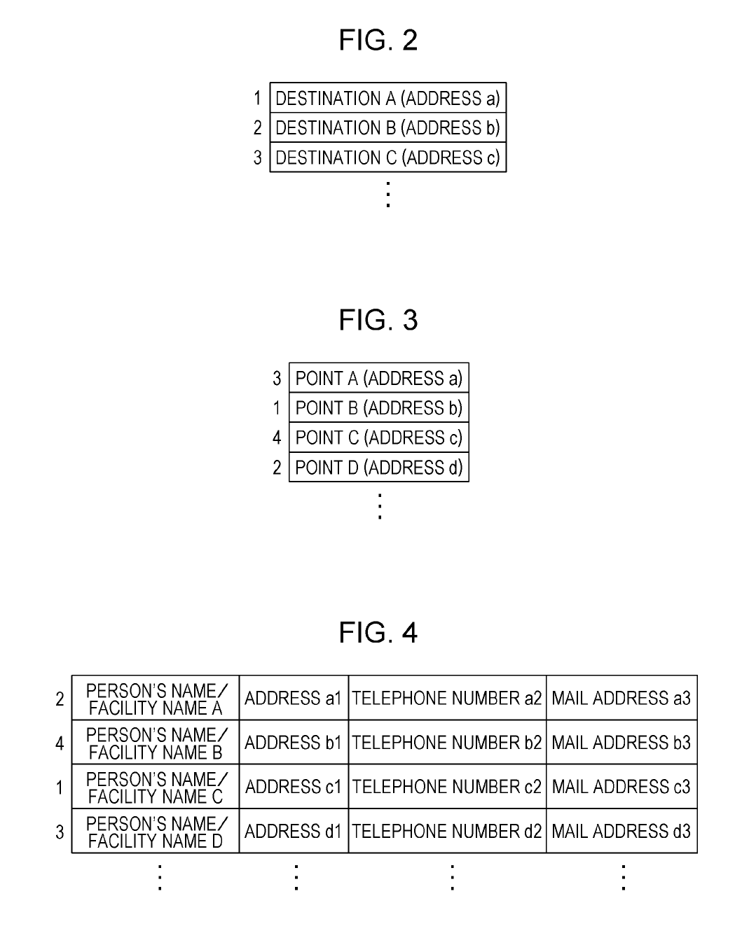

FIG. 2 is a diagram illustrating content of the destination history data 72. Numbers 1, 2, and 3 illustrated on a left side in FIG. 2 are serial numbers assigned from the latest date and time of a destination setting. Furthermore, destinations A, B, and C represent data which specifies set destinations and at least include addresses a, b, and c, respectively. Note that, if a facility name or the like may be specified as a destination, the map data 71 may be searched for an address corresponding to the facility name or the like, and accordingly, the destination history data 72 may be generated without including the addresses a, b, and c.

The facility/address specifying unit 52 specifies a point (a facility or an address) desired by the user to be registered in response to an operation of the operation unit 40 performed by the user. By specifying in this way, a home of the user or facilities or addresses which frequently set as destinations may be specified. As a concrete method for the specifying, as with the method for setting a destination employed by the destination setting unit 51 described above, the method for searching for a specific facility by the facility search unit 16 or the method for directly specifying a position in a map image is used. Data on the specified facility or the specified address is stored in the hard disk device 70 as the point registration data 73.

The point registration data 73 represents a position (a facility or an address) specified by the facility/address specifying unit 52. The point registration data 73 includes, for example, data specifying a predetermined number of points (10, for example).

FIG. 3 is a diagram illustrating content of the point registration data 73. Numbers 1, 2, 3, and 4 illustrated on a left side in FIG. 3 are serial numbers assigned from the latest date and time of registration. Furthermore, points A, B, C, and D represent data which specifies designated points and at least include addresses a, b, c, and d, respectively. Note that, if a facility name or the like may be specified, the map data 71 may be searched for an address corresponding to the facility name or the like, and accordingly, the point registration data 73 may be generated without including the addresses a, b, c and d.

The address book generation unit 53 generates an address book corresponding to individual person's names or individual facility names in response to operations of the operation unit 40 performed by the user. The address book may be obtained by inputting detailed data by operating the operation unit 40 or by reading address book data registered in the cellular phone 90 connected through the USB interface unit 80. The data on the address book is stored in the hard disk device 70 as the address book data 74.

FIG. 4 is a diagram illustrating content of the address book data 74. Numbers 1, 2, 3, and 4 illustrated on a left side in FIG. 4 are serial numbers assigned from the latest date and time of registration. Furthermore, person's name/facility name A, B, C, and D represent persons' names or facility names. Here, the “facility name” may be an exact name of a facility, an abbreviation, a nickname, or a sign representing a person or a group. Furthermore, it is not necessarily the case that all items including an address, a telephone number, and a mail address include data and only some of the items may include data.

The telephone processor 54 performs an outgoing call process of making a telephone call by means of the cellular phone 90 using one of telephone numbers included in the address book data 74 stored in the hard disk device 70 or using a telephone number directly input by the user using the operation unit 40. Furthermore, after a telephone line is connected to a communication partner, the telephone processor 54 performs a process of transmitting voice of a speaker collected by the microphone 22 to the communication partner, and in addition, outputting voice of the communication partner from the speaker 66. In this way, the handsfree telephone system using the cellular phone 90 is realized by the telephone processor 54.

The recognition result obtaining unit 55 obtains a result of the voice recognition performed by the voice recognition processor 24. The input processor 56 selects the result of the recognition performed by the voice recognition processor 24 obtained by the recognition result obtaining unit 55 or content of an operation performed by the operation unit 40 as content of an operation instruction or information input to the on-vehicle apparatus 1.

The speech example setting unit 57 reads certain data included in one of the destination history data 72, the point registration data 73, and the address book data 74 stored in the hard disk device 70 as registration data and sets an address included in (or corresponding to) the read data as a speech example. The speech example provision unit 58 provides, before an address is input by voice using the microphone 22, the speech example set by the speech example setting unit 57 (specifically, displays a character string representing an address).

The microphone 22 described above corresponds to voice collection means, the speech example provision unit 58 described above corresponds to speech example provision means, the hard disk device 70 described above corresponds to registration information storage means, the speech example setting unit 57 described above corresponds to speech example setting means, the voice recognition processor 24 described above corresponds to voice recognition means, and the facility search unit 16 described above corresponds to facility search means. Furthermore, the route search processor 14 described above corresponds to route search means, the destination setting unit 51 described above corresponds to destination setting means, the facility/address specifying unit 52 described above corresponds to facility/address specifying means, and the address book generation unit 53 described above corresponds to address specifying means.

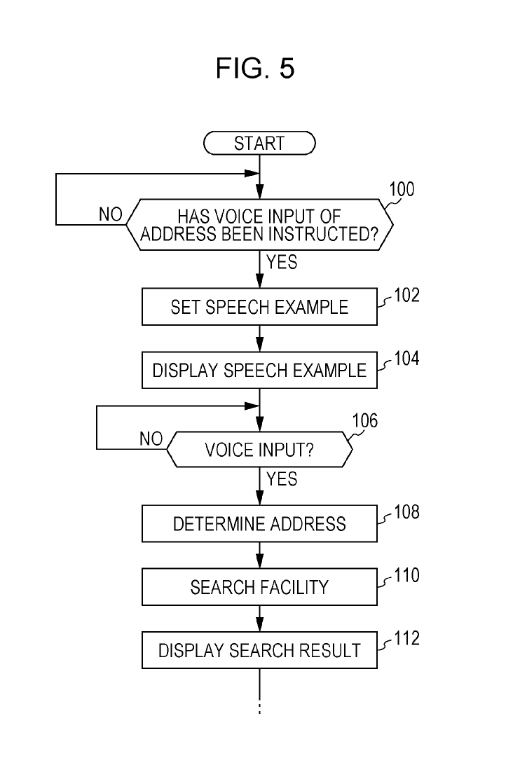

The on-vehicle apparatus 1 of this embodiment has the configuration described above. Next, operation of the on-vehicle apparatus 1 will be described. FIG. 5 is a flowchart illustrating a procedure of an operation of inputting an address of a facility to be searched for by voice.

First, the speech example setting unit 57 determines whether voice input of an address has been instructed (step 100). When voice input has not been instructed, a negative result is obtained and the determination is performed again. On the other hand, when voice input has been instructed, an affirmative result is obtained in the determination of step 100. It is determined that voice input has been instructed when input of an address is specified in a facility search screen, for example.

Subsequently, the speech example setting unit 57 sets a speech example (step 102). For example, data corresponding to a certain destination is selected from the destination history data 72 illustrated in FIG. 2, an address is extracted from the selected data, and a character string of the extracted address is set as a speech example. Examples of a method for selecting a certain destination include a method for selecting a destination which is most recently added (a destination corresponding to a serial number 1) or a method for randomly selecting a destination from all destinations or from among a predetermined number of destinations which are recently added.

Alternatively, data corresponding to a certain point is selected from the point registration data 73 illustrated in FIG. 3, an address is extracted from the selected data, and a character string of the extracted address is set as a speech example. Examples of a method for selecting a certain point include a method for selecting a point which is most recently added (a point corresponding to a serial number 1) or a method for randomly selecting a point from all points or from among a predetermined number of points which are recently added.

Alternatively, data corresponding to a certain person's name/facility name is selected from the address book data 74 illustrated in FIG. 4, an address is extracted from the selected data, and a character string of the extracted address is set as a speech example. Examples of a method for selecting a certain person's name/facility name include a method for selecting a person's name/facility name which is most recently added (a person's name/facility name corresponding to a serial number 1) or a method for randomly selecting a person's name/facility name in all person's names/facility names or from among a predetermined number of person's names/facility names which are recently added. Note that sonic of the person's names/facility names do not include corresponding addresses, and such person's names/facility names are excluded from targets of a setting of a speech example.

In the description above, one of the destination history data 72, the point registration data 73, and the address book data 74 is selected and a certain address is extracted from the selected one of the destination history data 72, the point registration data 73, and the address book data 74. However, two or all of the destination history data 72, the point registration data 73, and the address book data 74 may be selected and a certain address may be extracted from the two or all of the destination history data 72, the point registration data 73, and the address book data 74. In this case, an address included in data which is most recently registered is extracted or data is randomly selected and an address included in the selected data is extracted.

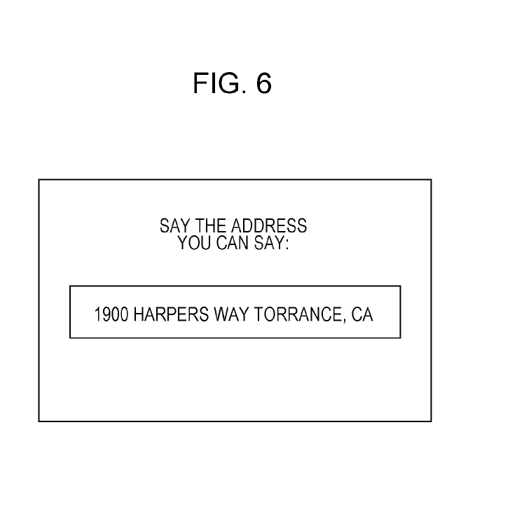

Next, the speech example provision unit 58 displays the address set as the speech example in the display device 62 (step 104). FIG. 6 is a diagram illustrating a display screen displaying a speech example. In FIG. 6, a character string “1900 HARPERS WAY TORRANCE, CA” included in the display screen represents an address as the speech example. This example is used when an address in the USA is to be input, and specifies arrangement (the order of input) including a name of a state and the like when the user inputs an address by voice. When the user checks the speech example, the address is prevented from being pronounced in wrong order by the user. For example, occurrence of a case where the user inputs a name of a state by voice first by mistake or the like may be prevented.

Thereafter, the input processor 56 determines whether the user has input an address by voice (step 106). When voice input has not been performed, a negative result is obtained and the determination is performed again. Also when input of an address which does not obey the speech example is performed and when an address is not specified due to ambiguous pronunciation, a negative result is obtained in the determination of step 106, and the determination is performed again.

When the user pronounces an address after the speech switch 42 is pressed, for example, so that voice input is performed, an affirmative result is obtained in the determination of step 106. In this case, the input processor 56 determines an address corresponding to the input voice (step 108). The facility search unit 16 searches for a facility corresponding to the determined address (step 110) and displays information on the facility as a result of the search in the display device 62 (step 112).

By this, in the on-vehicle apparatus 1 of this embodiment, since an address is extracted in accordance with information registered in response to a user's operation and is used as a speech example, a speech example which is familiar for the user may be provided when an address is to be input by voice. In particular, since an address is displayed in a form of a character string as a speech example, the address may be displayed as a speech example which is familiar for the user.

Furthermore, a voice recognition process is performed on voice of the user input after the speech example is checked, and a facility corresponding to an address represented by a character string obtained by the voice recognition process is searched for. By this, the user may search for a desired facility only by inputting an address by voice with reference to a familiar speech example.

Furthermore, a destination of route search corresponds to a location where the user actually visited or a location where the user plans to visit. Since an address of the location is used as a speech example, the speech example which is familiar for the user may be reliably provided. Alternatively, since a facility or an address in which the user desires to register is used as a speech example, the speech example which is familiar for the user may be reliably provided. Furthermore, since an address serving as address information specified by the user is used as a speech example, the speech example which is familiar for the user may be reliably provided.

Furthermore, since the latest address which most recently relates to the user is used as a speech example, the speech example which is familiar for the user may be reliably provided. Moreover, since an address is randomly extracted, various addresses which are familiar for the user may be extracted every time a speech example is to be displayed, and a speech example which is not bored by the user may be provided.

The present disclosure is not limited to the foregoing embodiment, and various modifications may be made within the scope of the present disclosure. In the foregoing embodiment, the case where the hard disk device 70 stores the destination history data 72, the point registration data 73, and the address book data 74 is described. However, it is not necessarily the case that the three pieces of data are required. Specifically, when one or two of the three pieces of data are stored, a certain one of the data may be selected, an address included in the selected data may be extracted, and the extracted address may be set as a speech example.

Furthermore, in the foregoing embodiment, an address included in each of the destination history data 72, the point registration data 73, and the address book data 74 is extracted. However, addresses in addresses included in the destination history data 72, the point registration data 73, and the address book data 74 which are not appropriate as a speech example may be excluded from extraction targets. In a case of an address in the USA, for example, when a name of a state is not included in the address or when a name of a state is included in a beginning portion or a middle portion of the address, the address is inappropriate. Furthermore, also in a case of an address of a country or a region in which a language other than languages assumed as targets of the voice recognition process is used, the address is inappropriate.

Furthermore, although the on-vehicle apparatus 1 installed in a vehicle is described in the foregoing embodiment, the present disclosure is applicable to a case where a speech example is provided for the user in a mobile terminal having a function the same as or similar to the function of the on-vehicle apparatus 1.

As described above, according to the present disclosure, since an address is extracted in accordance with information registered in response to a user's operation and is used as a speech example, a speech example which is familiar for the user may be provided when an address is to be input by voice.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teaching of the invention without departing from the central scope thereof. Therefore, it is intended that this invention not be limited to the particular embodiments disclosed, but that the invention will include all embodiments falling within the scope of the appended claims.

What is claimed is:

1. A facility search apparatus comprising:
a voice collection unit configured to input voice produced by a user;
a speech example provision unit configured to provide a speech example for the user before the voice input is performed using the voice collection unit;
a registration information storage unit configured to store registration information which is registered and updated in response to operations performed by the user and which includes an address itself or unique information used to specify the address; and
a speech example setting unit configured to read the registration information stored in the registration information storage unit and set the address corresponding to the registration information as the speech example.

2. The facility search apparatus according to claim 1, wherein
the speech example provision unit displays a character string representing content of the address serving as the speech example.

3. The facility search apparatus according to claim 1, further comprising:
a voice recognition unit configured to perform a voice recognition process on input voice collected by the voice collection unit; and
a facility search unit configured to search for a facility corresponding to an address represented by a character string obtained by the voice recognition process performed by the voice recognition unit.

4. The facility search apparatus according to claim 1, further comprising:
a route search unit configured to calculate a moving path to a destination by a route search process; and
a destination setting unit configured to set the destination in response to a user's operation,
wherein the registration information storage unit stores destinations set in the past by the destination setting unit as the registration information.

5. The facility search apparatus according to claim 1, further comprising:
a facility/address specifying unit configured to specify a facility or an address desired to be registered by the user in response to a user's operation,
wherein the registration information storage unit stores facilities or addresses specified in the past by the facility/address specifying unit as the registration information.

6. The facility search apparatus according to claim 1, further comprising:
an address specifying unit configured to specify an address corresponding to a person's name or a facility name as address information in response to a user's operation,
wherein the registration information storage unit stores address information specified in the past by the address specifying unit as the registration information.

7. The facility search apparatus according to claim 1, wherein
the speech example setting unit reads the registration information which is most recently stored from among a plurality of registration information stored in the registration information storage unit and sets an address corresponding to the read registration information as the speech example.

8. The facility search apparatus according to claim 1, wherein
the speech example setting unit reads registration information randomly selected from among a plurality of registration information stored in the registration information storage unit and sets an address corresponding to the read registration information as the speech example.

9. A facility search method comprising:
collecting voice produced by a user using a voice collection unit;
providing a speech example for the user using a speech example provision unit before voice input is performed using the voice collection unit; and
reading registration information stored in a registration information storage unit and setting an address corresponding to the registration information as the speech example using a speech example setting unit when the registration information which is registered and updated in response to operations performed by the user and which includes an address itself or unique information used to specify the address is stored in the registration information storage unit.

10. The facility search method of claim 9, further comprising:
displaying a character string representing content of the address serving as the speech example using the speech provision unit.

11. The facility search method of claim 9, further comprising:
performing a voice recognition process on input voice collected by the voice collection unit using a voice recognition unit; and,
searching for a facility corresponding to an address represented by a character string obtained by the voice recognition process performed by the voice recognition unit.

12. The facility search method of claim 9, further comprising:
calculating a moving path to a destination by a route search process using a route search unit; and,
setting the destination in response to a user's operation by using a destination setting unit;
wherein the registration information storage unit stores destinations set in the past by the destination setting unit as the registration information.

13. The facility search method of claim 9, further comprising:
specifying a facility or an address desired to be registered by the user in response to a user's operation using a facility/address specifying unit;
wherein the registration information storage untie stores facilities or addresses specified in the past by the facility/address specifying unit as the registration information.

14. The facility search method of claim 9, further comprising:
specifying an address corresponding to a persona' name or a facility name as address information in response to a user' operation by an address specifying unit;
wherein the registration information storage unit stores address information specified in the past by the address specifying unit as the registration information.

15. The facility search method of claim 9, further comprising:
reading the registration information which is most recently stored from among a plurality of registration information stored in the registration information storage unit; and,
setting an address corresponding to the read registration information as the speech example using the speech example setting unit.

16. The facility search method of claim 9, further comprising:
reading registration information randomly selected from among a plurality of registration information stored in the registration information storage unit; arid,
setting an address corresponding to the read registration information as the speech example using the speech example setting unit.
